(19) United States
(12) Patent Application Publication
(10) Pub. No.: US 2004/0220835 A1
(43) Pub. Date: Nov. 4, 2004

(54) Medical information system and method

(75) Inventors: Jay Z. Muchin, Manitowoc, WI (US); David J. Merten, Manitowoc, WI (US)

Correspondence Address: FOLEY & LARDNER, 777 EAST WISCONSIN AVENUE, SUITE 3800, MILWAUKEE, WI, 53202-5308, US

(73) Assignee: Meteor, LLC

(21) Appl. No.: 10/772,769

(22) Filed: Feb. 4, 2004

Related U.S. Application Data
(60) Provisional application No. 60/445,096, filed on Feb. 5, 2003.

(51) Int. Cl. G06F 17/60

(52) U.S. Cl. 705/3

(57) ABSTRACT

According to one exemplary embodiment, a method for arranging medical information includes finding a plurality of pages, dividing the plurality of pages into a plurality of main sections, associating a member with each of the main sections, recording identification information for each member in the main sections, dividing each main section into a plurality of subsections, recording a plurality of medical events in a first subsection of the plurality of sections, wherein each medical event includes a first reference indicia, recording a plurality of dental events in a second subsection, wherein each dental event includes a second reference indicia, recording a plurality of vision events in a third subsection, wherein each vision event includes a third reference indicia and recording a plurality of medication information entries in a fourth subsection, wherein each medication information entry includes a linking indicia corresponding to a reference indicia to link each medical entry to one of the medical event, the dental event or the vision event.

The present application claims priority under 35 U.S.C. § 119(e) based upon co-pending U.S. Provisional Patent Application Ser. No. 60/445,096 by Jay Z. Muchin and David J. Merten, filed on Feb. 5, 2003, the full disclosure of which is hereby incorporated by reference.

### BACKGROUND OF THE INVENTION

Organizing and tracking medical information is an extremely difficult task given that members of a family will typically visit a health care professional a multitude of times for vision needs, dental needs or other general medical needs. In most circumstances, completely different health care professionals must be consulted for each of the three general type of health care needs of a family member. The task of tracking and organizing such needs becomes more difficult as the size of the family grows. There is no central place or method or organization that keeps all of the medical records for a person. For instance, if a person uses a private internist, that internist will not have access to that person's medical records involving a physician at a different office or provider. There is no information link between different providers, so this daunting and important task falls solely in the hands of the individual. Similar problems arise with respect to the health care needs of other non-human members of the family such as pets.

Efficiently accessing such information is critical in many circumstances. For example, when applying to participate in physically strenuous activity such as sports and the like, an organization may inquire as to previous medical, dental or vision history. When seeking treatment, health care professionals frequently ask about an individual's medical history and whether or not the individual is currently or has taken any past medications. Moreover, the identification of past medical history or current or previously taken medications may be critical such as in an accident where the health care professional may need to immediately find out what, if any, medications the individual is taking or whether the individual has any allergies to any particular medications. In some circumstances, the individual requiring medical attention may be unconscious or unable to access the information. In another circumstance, an individual applying for new or additional insurance is required to have access to their full medical history in order to fill out the application accurately and completely. Failure to do so can render the coverage invalid.

### SUMMARY OF THE INVENTION

A method for arranging medical information includes finding a plurality of pages, dividing the plurality of pages into a plurality of main sections, associating a member with each of the main sections, recording identification information for each member in the main sections, dividing each main section into a plurality of subsections, recording a plurality of medical events in a first subsection of the plurality of sections, wherein each medical event includes a first reference indicia, recording a plurality of dental events in a second subsection, wherein each dental event includes a second reference indicia, recording a plurality of vision events in a third subsection, wherein each vision event includes a third reference indicia and recording a plurality of medication information entries in a fourth subsection, wherein each medication information entry includes a linking indicia corresponding to a reference indicia to link each medical entry to one of the medical event, the dental event or the vision event.

### BRIEF DESCRIPTION OF THE DRAWINGS

FIG. 1 is a top perspective view of medical information system according to one exemplary embodiment.

FIG. 2 is a bottom plan view of a member tab page of the system of FIG. 1.

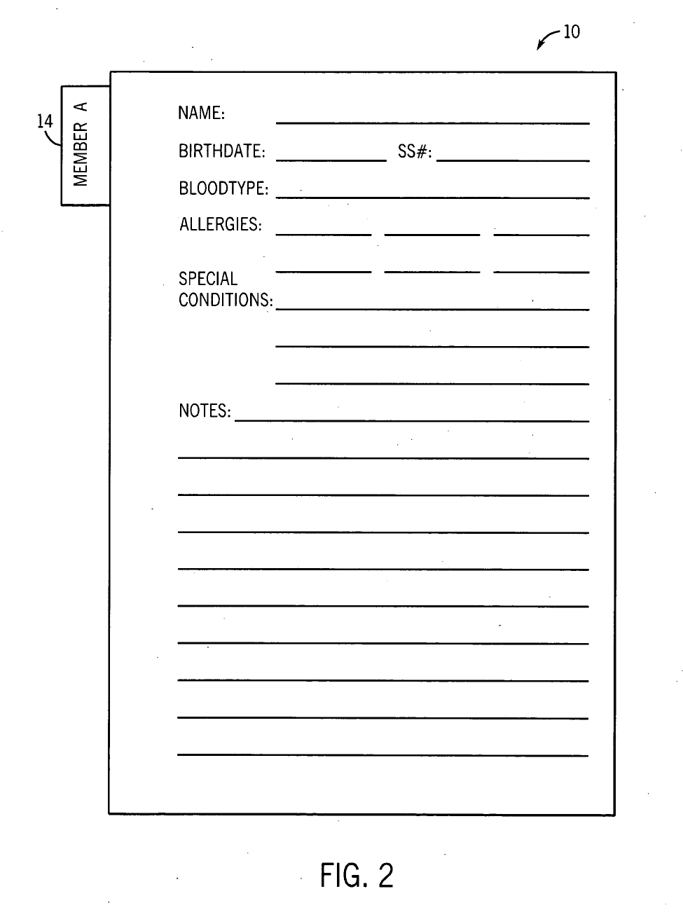

FIG. 3 is a bottom plan view of an immunization record page of a medical section of the system of FIG. 1.

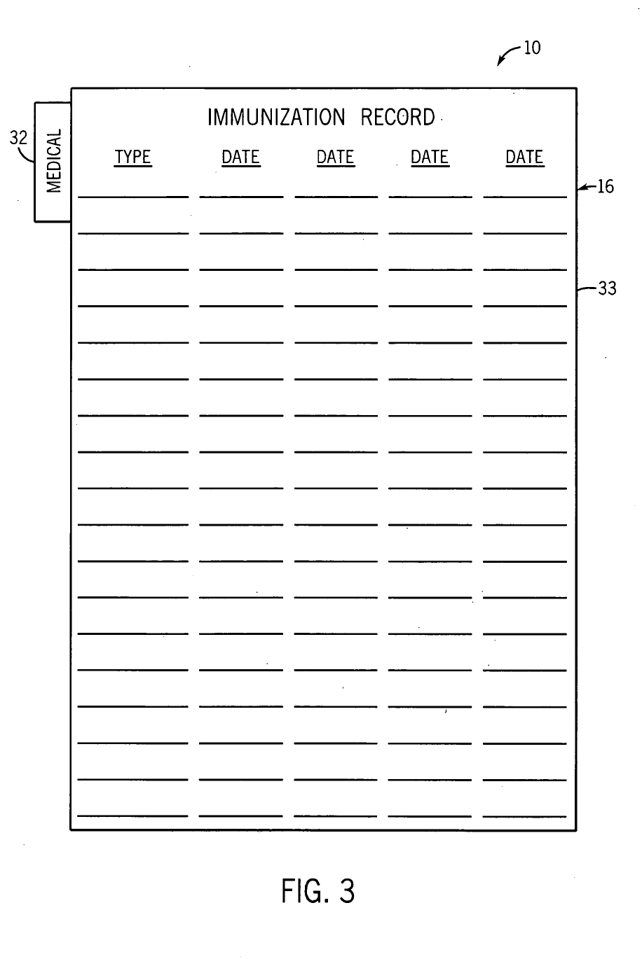

FIG. 4 is top plan view of a general medical section page of the system of FIG. 1.

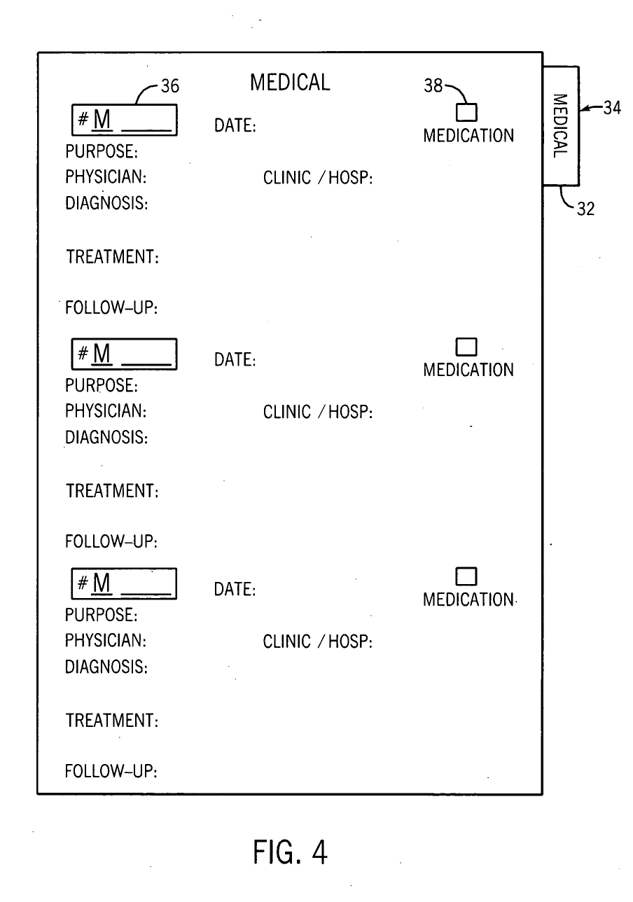

FIG. 5 is a bottom plan view of tooth history page of dental section of the system of FIG. 1.

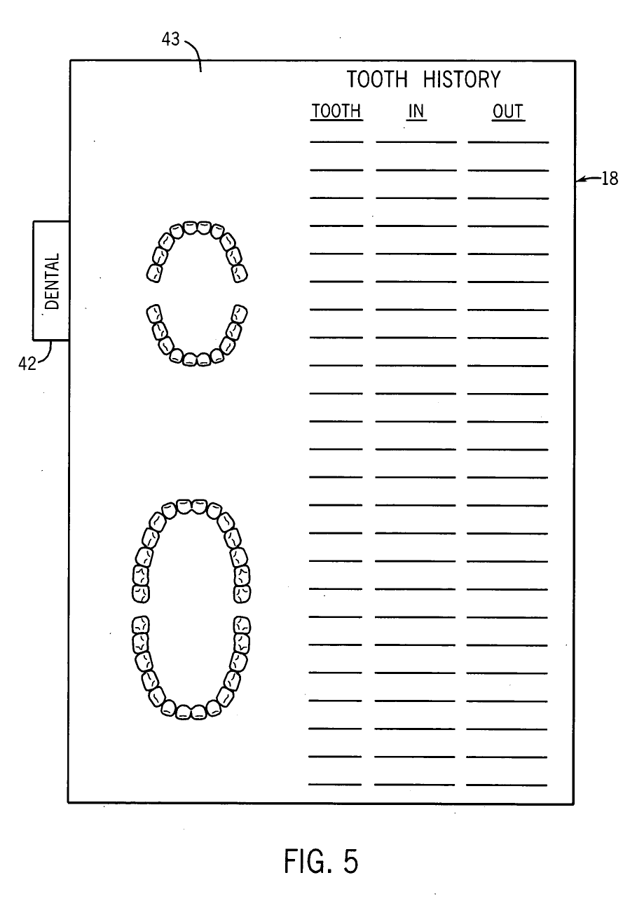

FIG. 6 is a top plan view of general dental section page of the system of FIG. 1.

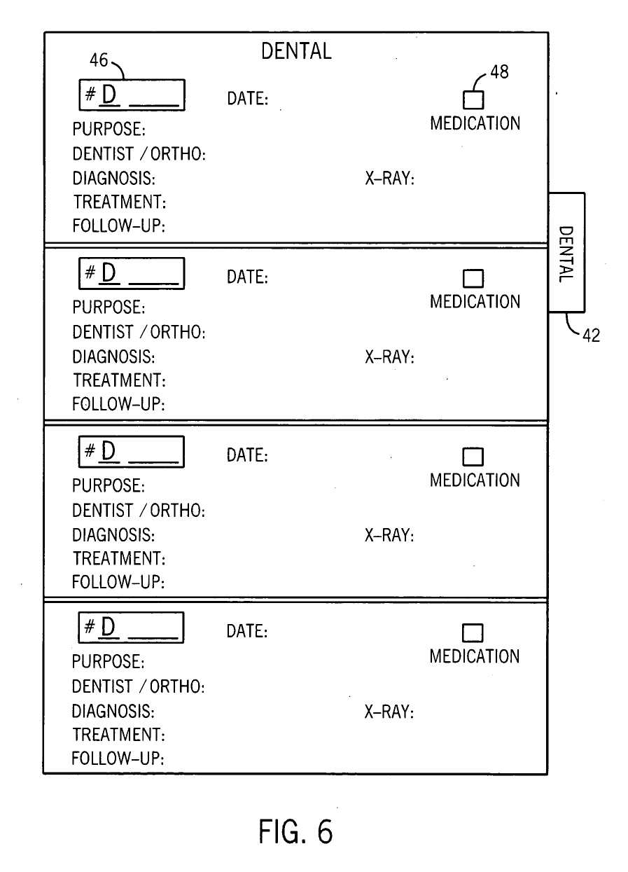

FIG. 7 is a bottom plan view of a vision history page of a vision section of the system of FIG. 1.

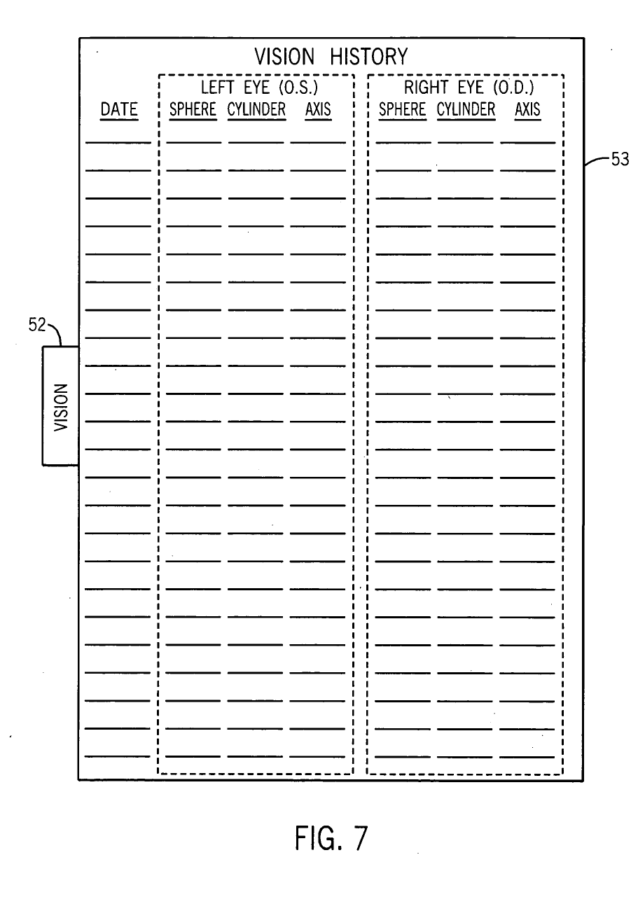

FIG. 8 is a top plan view of general vision section page of the system of FIG. 1.

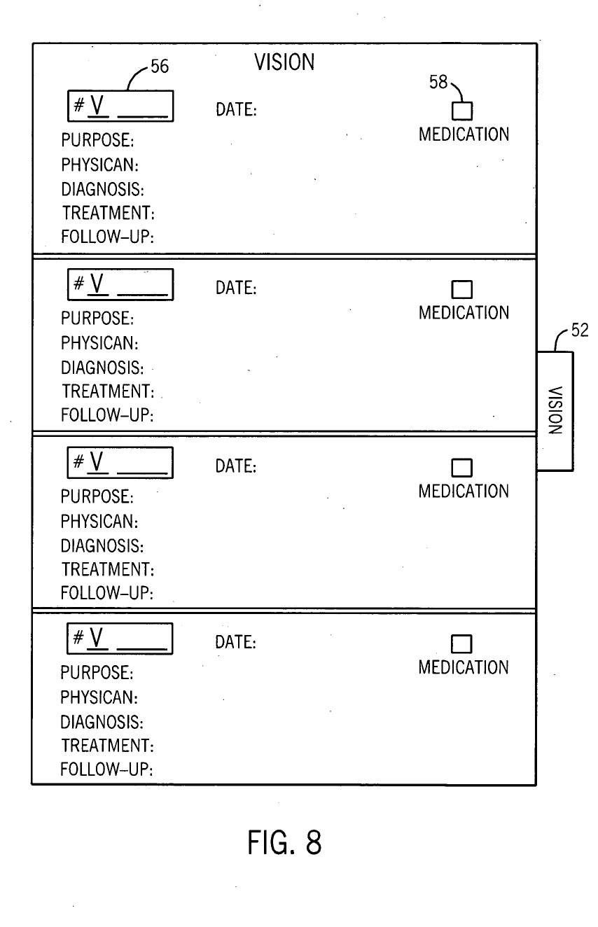

FIG. 9 is a top plan view of a general medication section page of the system of FIG. 1.

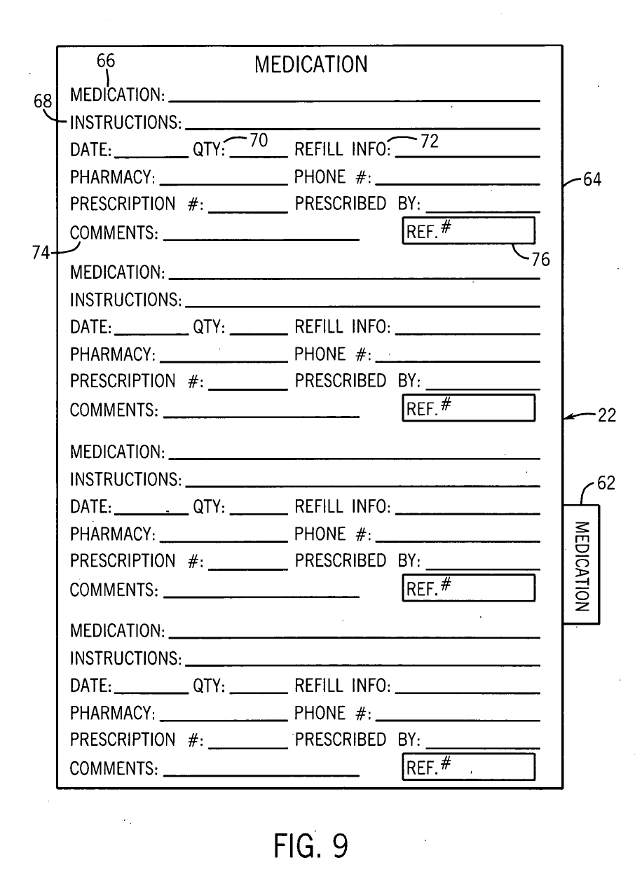

FIG. 10 is a bottom plan view of surgeries and hospitalizations page of a medication section of the system of FIG. 1

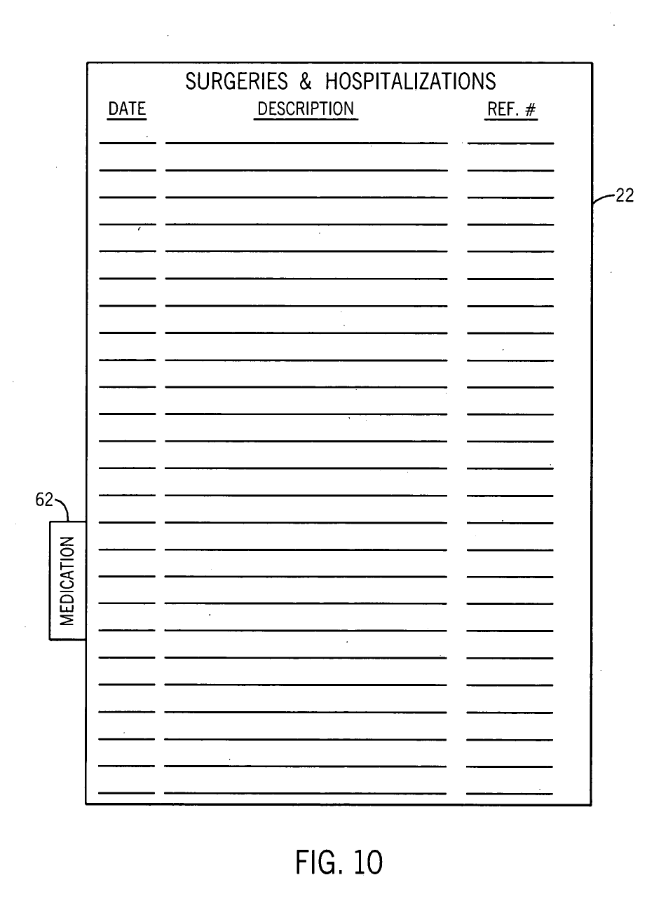

FIG. 11 is a bottom plan view of a blood donation log of a test results section of the system of FIG. 1.

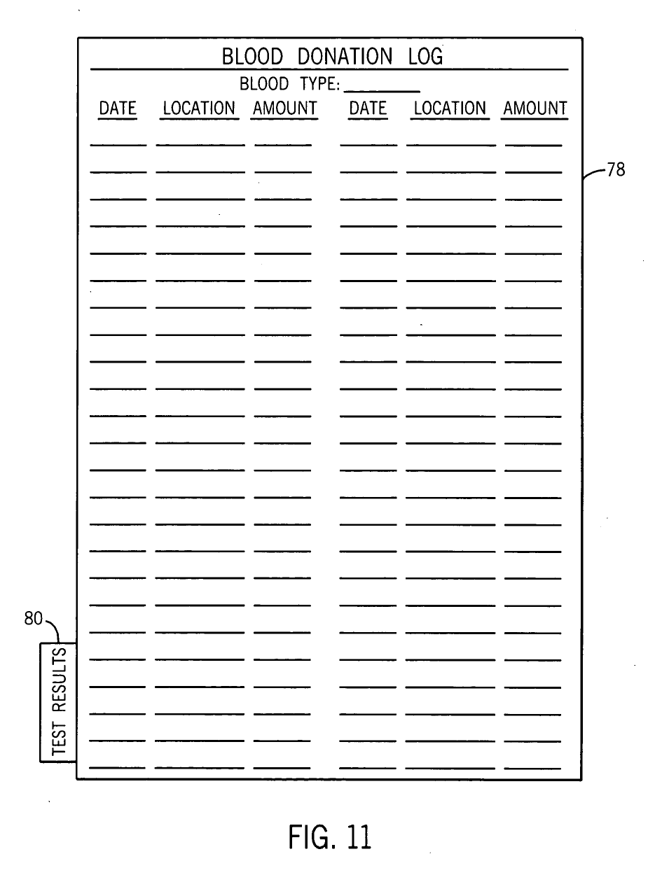

FIG. 12 is a top plan view of a general test results section page of the system of FIG. 1.

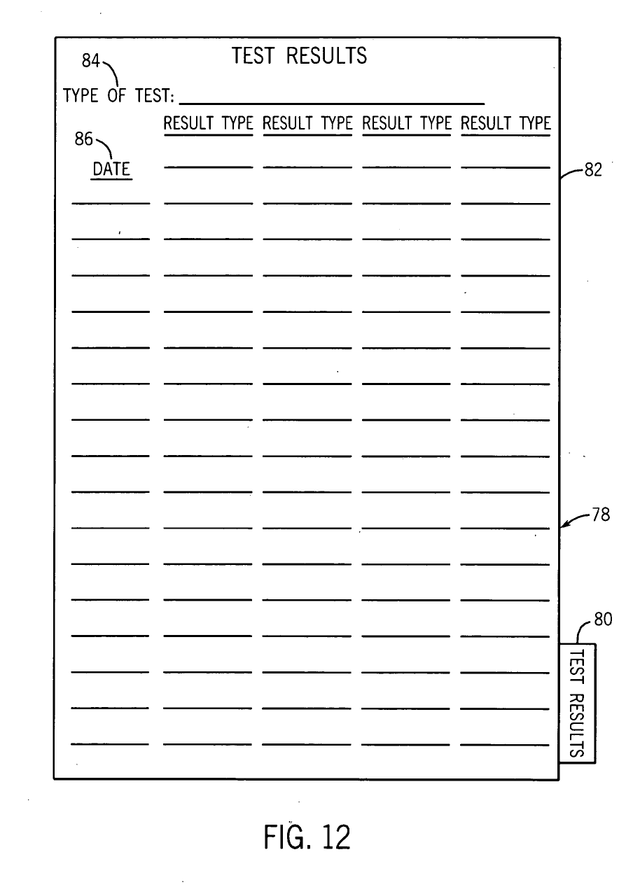

FIG. 13 is a top plan view of a general provider directory page of a directory section of the system of FIG. 1.

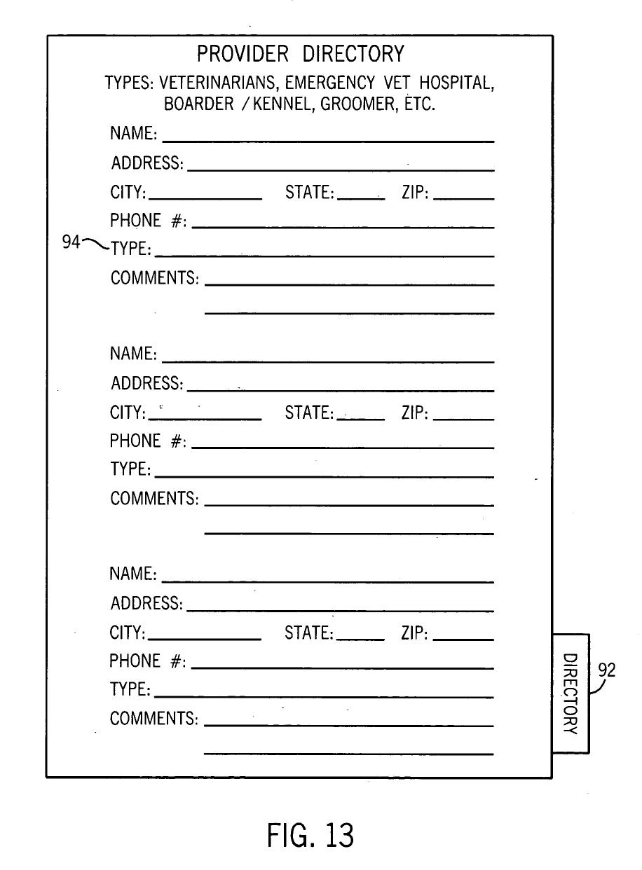

### DETAILED DESCRIPTION OF THE PREFERRED EMBODIMENTS

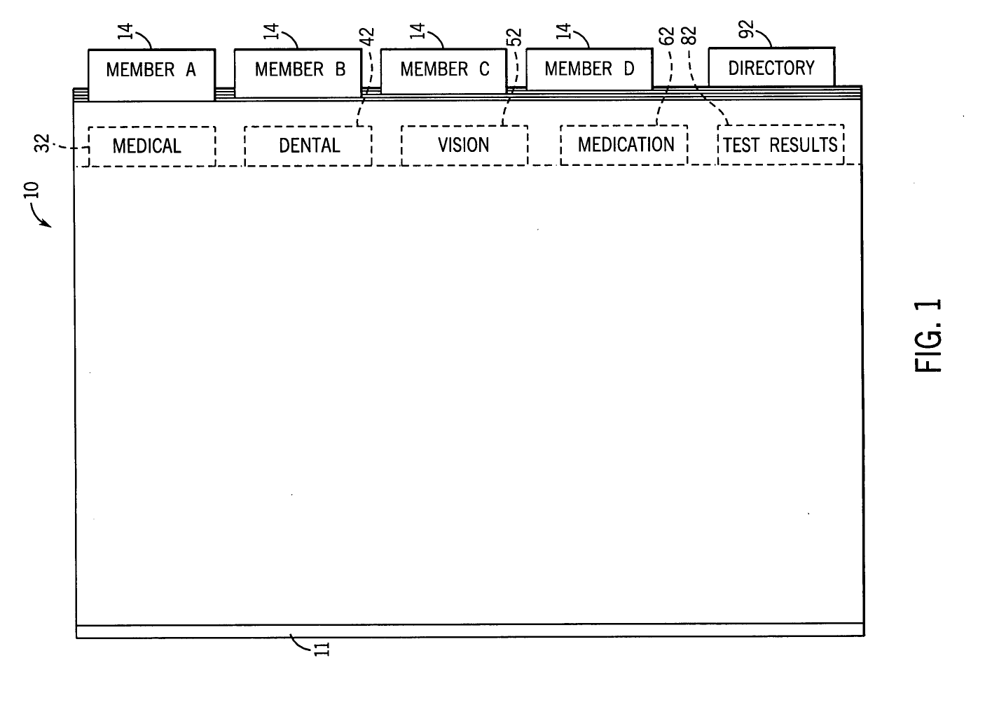

FIG. 1 depicts a medical information log or system 10 for arranging and organizing medical information to facilitate quick and easy access to such information, to provide a comprehensive but condensed list of medications an individual or family members may be taking and to organizationally link such medications to either a medical event, dental event or vision event which necessitated the medication. It also provides past history involving such medications and/or events.

System 10 generally includes an instruction section (not shown) and a plurality of tabbed sections 14 for members of a group or family. The sections include pages which are bound along a spine 11. Each tabbed section 14 includes a set of recessed tabs which identify medical, dental, vision, medication and test results subsections 16, 18, 20, 22, and 24 respectively for each member. The last tabbed section 92 of the system includes a directory 94 prompting the recordation of health care professional contact information such as contact information for physicians, clinics, insurers, hospitals, pharmacies and the like.

In addition to facilitating easy organization of information pertaining to medical, dental and vision events as well as medications resulting from such events, the system 10 further facilitates easy recordation of medical information. In particular, the pages prompting medication information entries are appropriately sized for enabling typical prescription labels (those issued by pharmacies) to be adhered or otherwise coupled to such pages. As a result, the risk of incorrect recordation of medication information is reduced. The instructions for taking or applying the medication are also correctly recorded as a result of this feature.

Family Member Tabs 14

The medical information system main tabs 14 are organized by the members of your family. On the back of this main Tab is an easy place to keep the vital individual information for that family member. From Blood Type and Allergies to Social Security # and any Special Conditions you might want to make note of. There's even a helpful area for Notes that can be used for anything you would like, such as special insurance information.

Medical Tab & Immunization Record

Tab 32 signifies the section 16 where all of a member's general medical information will be kept (see Medical Pages below). On the back of this tab is a helpful chart 33 for keeping track of the particular family member's Immunizations. Not only is this crucial information for babies, but a handy way for all of us to keep track of flu shots, tetanus shots, etc. Just fill in the type of immunization, or booster, on the far left and keep track of the dates on the right.

Medical Section 16

Within each family member's individual section are pages for Medical, Dental & Vision. The Medical pages 16 are for general Medical events such as a Doctor visit or keeping track of a particularly bad sore throat, etc. Some of the helpful features of these pages include:

Reference # box 36. In this area, simply fill in the number, i.e., 1, 2, 3. This will make it easy to refer to this ‘event’ when cross-referencing it with related information in other sections of the medical information system, such as the Medication section. The “M” before the number you write in refers to this “Medical” section.

Medication Box 38. This helpful box simply needs a ‘check mark’ if any medication was prescribed in conjunction with this office visit or ailment, etc. The details of the specific prescription or medication can be easily entered on the pages in the Medication section, with a helpful area to keep the printed prescription info that are obtained from a pharmacy (See Medication Pages below).

Dental Tab & Tooth History 18

Tab 42 signifies the section 18 where general dental information is kept (see Dental Pages below). On the back of tab 42 is a handy chart and diagram 43 to easily keep track of the particular family member's tooth history. For young children, it's an easy way to keep track of when a primary tooth fell out, and when the corresponding permanent tooth arrived. For older adults, it's a helpful way to keep track of when a tooth was removed and when a corresponding bridge or denture was put in place.

Dental Pages 44

Here is where it's easy to keep track of each person's Dental information. These pages are particularly helpful to keep track of visits to the dentist, whether it be for semi-annual Check-Ups, particular tooth-related problems, or even just a handy way to keep track of when those precious baby teeth fell out. Some of the helpful features of these pages include:

Reference # Box 46—As with the Medical pages, in this area, simply fill in the number, i.e., 1, 2, 3. This will make it easy to refer to this ‘event’ when cross-referencing it with related information in other sections of the medical information system, such as the Medication section. The “D” before the number you write in refers to this “Dental” section.

Medication Box 48—This helpful box simply needs a ‘check mark’ if any medication was prescribed in conjunction with this office visit or ailment, etc. Here is where a member can keep track of the particular painkiller the dentist prescribed. The details of the specific prescription and medication can be easily entered on the pages in the Medication section, with a helpful area to keep the printed prescription info that are obtained directly from your pharmacy.

Vision Tab & Vision History 20

Tab 52 signifies the section 20 where all of your general vision-related information will be kept (see Vision Pages below). On the back tab 52 is a convenient chart 53 for keeping track of a family member's technical information regarding their eyes. For those needing glasses or contacts, it's important to have this detailed information as well as to see how a member's eyes are changing over time. Do I need to strengthen my glasses? This will make it easier to see.

Vision Pages 54

This is a handy place to keep track of each person's Eye-related information. Whether it's eye exams for the children, glasses for the adults, or cataract prevention down the road, it will be easy to log right here. Some of the helpful features of these pages include:

Reference # Box 56—As with the Medical and Dental pages, in this area, simply fill in the number, i.e., 1, 2, 3. This makes it easy to refer to this ‘event’ when cross-referencing it with related information in other sections of the medical information system, such as the Medication section. This “V” before the number you write in refers to this “Vision” section.

Medication Box 58—This helpful box simply needs a ‘check mark’ if any medication was prescribed in conjunction with a particular on-going condition, or a one-time accident. The details of the specific medication can be easily entered on the pages in the Medication section, with a helpful area to keep the printed prescription info that one may directly from your pharmacy, if you'd like (See Medication Pages below).

Medication 22

Tab 62 holds the important section 22 where all Medication information will be kept (see Medication Pages below). The medication section 22 includes a chart 63 for recording surgeries and hospitalizations.

Medication Pages 64

This is a helpful and important place to keep track of each person's Medication information and Prescriptions. It's important to know what medications have been prescribed, but there's no good way to keep the information. Most people keep the actual containers on hand for reference, but that can be dangerous, especially with pills remaining inside. Some of the helpful features of these pages include:

Medication 66—This area is for the name and brand of the medication Today, the brand is important, as many insurance plans cover some (and Generics) but not others. This is also the place to list the Strength/Dilution of the dosage, i.e. “Generisol 2MG/5ML Syrup”.

Instructions 68—As the saying goes, to keep the Doctor away, this is the place to write “Take one apple, once per day” . . . or “Take two Tablespoons, three times per-day, for five days”, etc.

Qty 70—The number of pills or the quantity of liquid.

Refill Info 72—This is an area to list info such as “6 refills within one year”, etc.

Comments 74—This is the perfect place to list any additional info, whether it be “Caused Nausea, only took 3 times” to “Worked best on empty stomach”, etc.

Reference # Box 76—This is the place to fill in the Reference # from the section and event it relates to. For instance, if one had surgery and listed it in the Medical section as “M7”, and the Doctor prescribed a prescription for pain medication, you would write “M7” in this Reference # Box to be able to easily find the reason that the medication was prescribed. This can also be done with over-the-counter medications as well.

Another helpful option is to take the duplicate copy of the prescription information provided to you by your pharmacy and adhere it right on top of this section. It will contain this information. If size allows, it may be placed just above the Comments and Ref. # Box so this information is still handy and visible.

Test Results Tab & Blood Donation History 78

This tab 82 indicates one organized place or section 24 to keep track of info related to Test Results (see Test Results Pages below). On the backside is a handy log to be able to keep track of when, where and how much blood you donate.

Test Results Pages 84

This is an easy place to organize important results of various tests, both ongoing and one-time. For example, if you get your cholesterol checked twice a year, this provides an easy place to keep that data and see how it changes over time.

Type of Test 86—This section is where a member writes the actual type of test—Cholesterol, Blood Sugar, Blood Pressure, etc.

Result Type Boxes 88—Write in the individual types of results that you receive based on the type of test, and this will function as the column heading. For example, for a Cholesterol test, one may write “HDL” in one box, “LDL” in the next, and “Triglycerides”, etc. One may even keep track of general Check-up information, by writing “Check-up” in the Type of Test line, and then putting “Height” and “Weight” in two of the Result Type boxes.

Date 90—The lines under the Date heading are where you enter the individual dates of the particular test, with the individual Result Types going across from right to left. This allows one to easily see any changes over time, resulting in good preventative action.

Directory Tab 92

This section includes important information about your various health providers.

Provider Information Pages 94

These pages provide an organized and easy reference area to keep the helpful details about Physicians, Clinics, Insurers, Hospitals, and Pharmacies, etc.

Type 96—This is the area to write in what type of Provider it is (see above).

Overall, the medical information system provides a method for arranging medical information wherein a single section identifies all medication for a particular member and links such medication information entries to one of a medical event, a dental event or a vision event which are also recorded in other sections of the system. In a similar manner, surgeries and hospitalizations recorded in the system are also linked to one of a medical event, a dental event or a vision event. Such cross referencing enables the system to provide critical medication and surgery information as well as a history of such prescribed medications or resulting surgeries in a quick and efficient manner. The same system is also provided for use with animals such as pets.

Although the present invention has been described with reference to preferred embodiments, workers skilled in the art will recognize that changes may be made in form and detail without departing from the spirit and scope of the invention. For example, although different preferred embodiments may have been described as including one or more features providing one or more benefits, it is contemplated that the described features may be interchanged with one another or alternatively be combined with one another in the described preferred embodiments or in other alternative embodiments. Because the technology of the present invention is relatively complex, not all changes in the technology are foreseeable. The present invention described with reference to the preferred embodiments and set forth in the above definitions is manifestly intended to be as broad as possible. For example, unless specifically otherwise noted, the definitions reciting a single particular element also encompass a plurality of such particular elements.

What is claimed is:

1. A method for arranging medical information, the method comprising:
binding a plurality of pages;
dividing the plurality of pages into a plurality of main sections;
associating a member with each of the main sections;
recording identification information for each member in the main sections;
dividing each main section into a plurality of subsections;
recording a plurality of medical events in a first subsection of the plurality of subsections, wherein each medical event includes a first reference indicia;
recording a plurality of dental events in a second subsection, wherein each dental event includes a second reference indicia;
recording a plurality of vision events in a third subsection, wherein each vision event includes a third reference indicia; and
recording a plurality of medication information entries in a fourth subsection, wherein each medication information entry includes a linking indicia correspondirig to a reference indicia to link each medication entry to one of the medical event, the dental event or the vision event.

2. The method of claim 1, wherein recording medical information entries includes coupling a prescription label to the fourth subsection.

3. The method of claim 2, wherein coupling includes adhering the prescription label to the fourth subsection.

4. A medical information system comprising:
a plurality of sections bound together, each section corresponding to a member of a group, each section including:
a first subsection prompting recordation of a medical event;
a second subsection prompting recordation of a dental event;
a third subsection prompting recordation of a vision event; and
a fourth subsection prompting recordation of medication information, wherein each of the first three subsections further prompts recordation of or includes a reference indicia and wherein the fourth subsection further prompts recordation of or includes a linking indicia corresponding to a reference indicia to link each medication information entry to one of the medical event, the dental event or the vision event.

5. A medical information system comprising:
a plurality of sections bound together, each section corresponding to a member of a group, each section including:
a first subsection prompting recordation of a medical event;
a second subsection prompting recordation of a dental event;
a third subsection prompting recordation of a vision event; and
a log found within a fourth subsection prompting recordation of information logging surgeries and/or hospitalizations, wherein each of the first three subsections further includes a reference indicia and wherein the log found within the fourth subsection further prompts recordation of or includes a linking indicia corresponding to a reference indicia to link each surgery and/or hospitalization entry to one of the medical event, the dental event or the vision event.
